(19) United States
(12) Patent Application Publication
(10) Pub. No.: US 2004/0185132 A1
(43) Pub. Date: Sep. 23, 2004

(54) Removable flow diverter for an extrusion head

(75) Inventors: Ernest Wilford Looman JR., Tallmadge, OH (US); Bruce Joseph Turner, Wadsworth, OH (US); Malcolm George Marshall, Wadsworth, OH (US); Gary Robert Burg, Massillon, OH (US); Neil Phillip Stuber, Munroe Falls, OH (US)

Correspondence Address: Clement H. Luken, Jr., Esq., Wood, Herron & Evans, L.L.P., 2700 Carew Tower, 441 Vine Street, Cincinnati, OH, 45202-2917, US

(73) Assignee: The Goodyear Tire & Rubber Company

(21) Appl. No.: 10/392,069

(22) Filed: Mar. 19, 2003

(51) Int. Cl. B29C 47/70

(52) U.S. Cl. 425/192 R; 425/382.4; 29/525.01

(57) ABSTRACT

An extruder head for use in forming at least one strip of polymeric material. The extruder head includes a flow channel having a flow inlet end and a flow outlet end. A flow diverter is removably secured within the flow channel of the extruder head. The flow diverter is held securely in place within the flow channel by a fastening mechanism, and the flow diverter can be easily removed from the flow channel for reshaping or reprofiling as may be necessary to achieve a desired velocity profile of polymeric material flow at the flow outlet end of the flow channel.

### FIELD OF THE INVENTION

The present invention relates generally to extruder heads for forming strips of polymeric material and, more particularly, to a flow diverter for use in such an extruder head for directing the flow of polymeric material through the extruder head.

### BACKGROUND OF THE INVENTION

Extruders are well known in the art for extruding strips of polymeric material, such as rubber tire treads for example, from a profile forming die. Typical extruders include a heated barrel and a screw that provides shear energy to the material to be plasticized. As the material is heated, it generally converts from a solid pellet or strip form into a plasticized material at the end of the screw tip that conveys the material into an extruder head. The extruder head generally has a flow channel comprised of one or more flow passages that direct the plasticized material through the extruder head to the profile forming die that forms the material into the proper predetermined cross-sectional profile.

Oftentimes the extruder system is of a complex nature providing two or more dissimilar materials to be extruded. In one example, a duplex tire tread can be made with a top cap material and a lower base material, each material being specifically designed for its application. In even more complex applications, a triplex extruder can-be used in which the cap material and base material also have on each lateral extreme a sidewall material that is simultaneously coextruded and bonded to the other two components. All of these materials are conveyed into the extruder head that directs the materials into the flow channel which assembles and bonds them so that they come out as one or more solid singular pieces.

It is critical that the flow channel provide a balanced flow of material through the extruder head so that the rubber material flow has a velocity profile that is generally constant across the lateral length of the profiling die. Otherwise, the profiling die will have the material coming out and swelling to a larger area on one side of the die because it has a higher velocity flow rate than the material on the opposite side of the die. A secondary problem that also relates to the mass and velocity imbalance across the die is an undesirable curvature of the extrudate after it leaves the die, such that instead of obtaining a straight strip, a “banana”-shaped curved strip is obtained. This problem is also somewhat related to the velocity distribution in the material as it flows through the flow channel. If one can visualize an extrudate coming out of the die as a flat sheet, the material along the lateral edges of the die may be moving at different velocities such that one side of the extruded material will tend to bow or bend toward the other side that is moving at a slower velocity, the slower side tending to stay close to the die while the faster moving side is moving quicker away from the die. The resulting effect is a “banana” shaped curvature of the profiled component. This curvature as the component is formed is an indication that the velocities of the material are dissimilar from one side of the die to the other even though the dimensional characteristics of the profile component may seem accurate. This non-uniform velocity change causes the component to have a natural bow. In the preparation of tire treads for example, this effect can have some detrimental effect on the product quality of the resultant tire since the accuracy with which the tread can be applied to an unvulcanized tire is reduced and an asymmetry in the molded tire, know as conicity, can be created.

In order to compensate for these variations in flow velocities within an extruder head, one or more flow diverters are provided in the flow channel to vary the mass flow velocity through the flow channel. The flow diverters are machined into the flow channel which forms part of the extruder head. The flow channel may be a separate and removable component, typically made of metal such as steel, which is bolted to the extruder head. Alternatively, the flow channel and flow diverters may be machined directly into the extruder head, thereby eliminating the separate flow channel component. Each flow diverter is generally triangular in shape and includes a leading apex directed to the flow inlet end of the flow channel. Each flow diverter has a particular profile or shape, and orientation within the flow channel, so that the rubber flow has a velocity profile that is generally constant across the lateral length of the profiling die.

In order to achieve this result, the tool maker oftentimes has to vary the shape or profile of the flow diverters to insure that the velocity profiles of the rubber flow as it approaches the die are as uniform as possible. In practice, this requires the entire extruder head or separate flow channel component to be removed and transported to a location where the profiles of the flow diverters can be machined or manually grinded to a desired shape to achieve the desired flow balance through the profiling die. Once the extruder head or removable flow channel is returned for use in extruding strips of material, oftentimes it must be removed again for additional fine tuning to create the proper material flow characteristics through the flow channel. This movement of the extruder head or removable flow channel for adjustment purposes is cumbersome, time consuming and leads to potentially expensive downtime while the extruder head or removable flow channel is out of use for fine tuning.

Therefore, there is a need for an improved manner of balancing the flow of material through an extruder head such that the material flow has a generally constant velocity profile across the lateral length of the profile forming die during an extrusion process.

### SUMMARY OF THE INVENTION

The present invention overcomes the foregoing and other shortcomings and drawbacks of the extrusion systems and methods heretofore known. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, an extruder head is provided for forming one or more strips of polymeric material, such as one or more rubber tire treads for example. The extruder head includes a flow channel which is bolted to or, alternatively, machined into the extruder head for conveying the polymeric material through the extruder head between a flow inlet end and a flow outlet end of the flow channel. The flow channel receives polymeric material from an extruder at the flow inlet end and discharges the polymeric material at the flow outlet end through a die for forming the profile of the polymeric material to be produced. The die has one or more openings configured to form the polymeric material into one or more strips having the proper predetermined cross-sectional profile.

In one embodiment, a flow dam is provided in the flow channel for separating the flow channel into a first flow passage and a second flow passage. The flow dam effectively balances the amount of material mass flowing through each of the first and second flow passages so that they are approximately equal in mass of material being conveyed through each of the flow passages.

A pair of flow diverters are provided in the flow channel, with each flow diverter being located in one of the flow passages proximate the flow outlet end of the flow channel. Each flow diverter is generally triangular in shape and includes a leading apex directed toward the flow inlet end of the flow channel. Each flow diverter has a particular profile or shape, and orientation within the respective flow passages, so that the polymeric material has a velocity profile that is generally constant across the lateral length of the profile forming die.

In accordance with the principles of the present invention, the flow diverters are removably secured within the flow channel of the extruder head such that the flow diverters can be easily removed and reshaped or reprofiled as may be necessary to achieve the desired velocity profile of the polymeric material flow at the profile forming die. In one embodiment, threaded fasteners are provided which extend through bores formed through the flow diverters. The threaded ends of the fasteners engage threaded bores formed in the extruder head or removable flow channel such that the flow diverters are held securely in place within the flow channel of the extruder head, and can be easily removed as may be necessary simply by removing the fasteners. In this way, each flow diverter, which may weigh about 10 pounds, can be unbolted from the extruder head or removable flow channel and transported to any location for adjustment in its shape or profile by machining or manual grinding so that the desired velocity profile at the profile forming die is achieved.

This capability to remove and transport the flow diverters for adjustment greatly simplifies the prior adjustment process which required the massive one-piece extruder head or the removable flow channel to be removed and transported for machining or manual grinding. By removably securing the flow diverters within the flow channel of the extruder head, considerable time and expense is saved for adjusting the flow properties of the flow channel since now only the relatively light weight flow diverters need be removed and transported for adjustment.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a top plan view of a dual cavity extruder head having a pair of flow diverters removably secured within the flow channel of the extruder head in accordance with one embodiment of the present invention;

FIG. 2 is a cross-sectional view taken along line 2-2 of FIG. 1;

FIG. 3 is a perspective view of the dual cavity extruder head of FIG. 1, showing one of the flow diverters unconnected and removed from the flow channel of the extruder head;

FIG. 4 is a view similar to FIG. 3, showing the pair of flow diverters removably secured within the flow channel of the extruder head through a plurality of fasteners;

FIG. 5 is a top plan view of a single cavity extruder head having a flow diverter removably secured within the flow channel of the extruder head in accordance with another embodiment of the present invention;

FIG. 6 is a cross-sectional view taken along line 6-6 of FIG. 5;

FIG. 7 is a perspective view of the single cavity extruder head of FIG. 5, showing the flow diverter unconnected and removed from the flow channel of the extruder head; and

FIG. 8 is a view similar to FIG. 7, showing the flow diverter removably secured within the flow channel of the extruder head through a plurality of fasteners.

### DETAILED DESCRIPTION OF THE PREFERRED EMBODIMENT

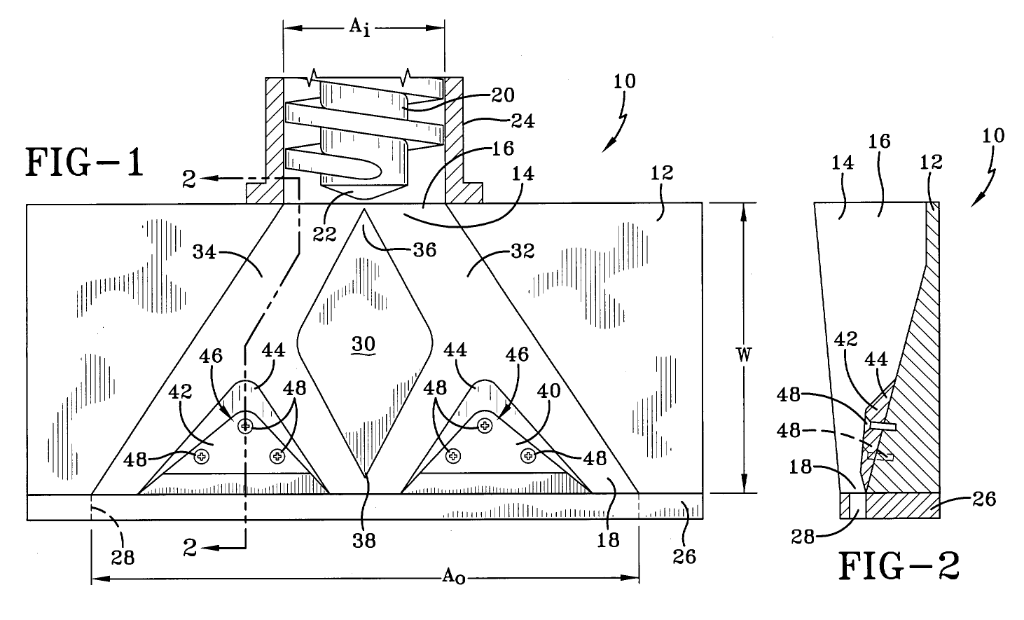

Referring now to the Figures, and to FIG. 1 in particular, an extrusion system 10 is shown in accordance with one embodiment of the present invention having a dual cavity extruder head 12 for forming one or more strips of polymeric material, such as one or more rubber tire treads by way of example. In one embodiment, the extruder head 12 is made of metal such as steel, and has a flow channel 14 machined therein for conveying polymeric material, including plasticized and elastomeric materials, through the extruder head 12 between a flow inlet end 16 and a flow outlet end 18 of the flow channel 14 as will be described in more detail below. As shown in FIG. 1, the flow inlet end 16 of the flow channel 14 has a predetermined cross-sectional area defined by a diameter “Aᵢ” and the flow outlet end 18 has a predetermined cross-sectional area defined by “Aₒ” and some gauge. While not shown, it will be appreciated by those of ordinary skill in the art that the flow channel may alternatively comprise a separate and removable component, typically made of steel, which is bolted to the extruder head 12. As used herein, the term “flow channel” is intended to include both a flow channel 14 which is machined into the extruder head 12 and a flow channel which is a separate and removable component bolted to the extruder head 12.

Further referring to FIG. 1, an extruder (not shown) well known in the art is connected to the extruder head 12 proximate the flow inlet end 16 of the flow channel 14. The extruder (not shown) includes an extruder screw 20 enclosed in an extruder barrel 24 and having a screw tip 22 on the discharge end of the screw. The flow channel 14 receives polymeric material from the extruder (not shown) at the flow inlet end 16 and discharges the polymeric material at the flow outlet end 18 through a die 26 for forming the profile of the polymeric strip to be produced. The die 26 is commonly referred to as a discharge die or profile forming die and has one or more openings 28 (FIG. 2) configured to form the polymeric material into one or more strips having the proper predetermined cross-sectional profile.

As shown in the embodiment of FIG. 1, a flow dam 30 is positioned in the flow channel 14 for separating the flow channel 14 into a first flow passage 32 and a second flow passage 34. The flow dam 30 includes a leading apex 36 directed toward the flow inlet end 16 and a trailing apex 38 directed toward the flow outlet end 18. In one embodiment, the leading apex 36 of the flow dam 30 is symmetrically oriented relative to the flow inlet end 16 of the flow channel 14 to effectively balance the amount of material mass flowing through each of the first and second flow passages 32, 34 so that they are approximately equal in mass of material. In another embodiment, additional flow diverting structure (not shown) may be provided at the leading apex 36 of the flow dam 30 to redistribute the mass of polymeric material flowing through the first and second flow passages 32, 34 so that there is effectively a balance of material mass flowing through the first and second flow passages 32, 34. Although not required, the flow dam 30 can extend the full length “W” of the flow channel 14, thereby completely separating the first flow passage 32 from the second flow passage 34 at the flow outlet end 18 of the flow channel 14. In this instance, the profile forming die 26 may include a pair of openings 28 to simultaneously produce a pair of profiled polymeric strips, one being formed from each flow passage 32 and 34.

Further referring to FIGS. 1 and 2, it will be seen that at least one or both of the surfaces of the flow channel 14 tapers inwardly from the flow inlet end 16 to the flow outlet end 18. The flow passages 32, 34 further elongate laterally so as to flatten the cross-sectional area as the polymeric material flow approaches the flow outlet end 18 of the flow channel 14 and prior to entering into the extruder profile forming die 26.

As shown in FIGS. 1-4, a pair of flow diverters 40, 42, made of metal such as steel, are positioned within the flow channel 14, with each flow diverter 40, 42 being located in one of the flow passages 32, 34 proximate the flow outlet end 18 of the flow channel 14. Each flow diverter 40, 42 is generally triangular in shape and includes a leading apex 44 directed toward the flow inlet end 16 of the flow channel 14. Each flow diverter 40, 42 has a particular profile or shape, and orientation within the respective flow passage 32, 34, so that the polymeric material has a velocity profile that is generally constant or as desired across the lateral length of the die 26 as it enters the die 26 at the flow outlet end 18 of the flow channel 14. It is believed that the apex 44 of each flow diverter 40, 42 should be positioned so that it impinges normal to the velocity profile of the polymeric material flowing within each respective flow passages 32, 34. If the material impinges the flow diverters 40, 42 with an angular flow, it is believed that the flow diverters 40, 42 should be asymmetrically positioned to insure that they intercept at the maximum flow velocity within the flow channel 14. If the flow channel 14 is provided such that the velocity profile of the polymeric flow in each flow passage 32, 34 is symmetrical prior to the leading apexes 44, then it is presumed that the flow diverters 40, 42 could be positioned symmetrically within the flow channel 14 near the flow outlet end 18 because in that construction the maximum flow velocity would be presumed to be at the midpoint of each flow passage 32, 34 or in close proximity thereto. In one embodiment, as shown in FIG. 2, each flow diverter 40, 42 occupies about 40 percent or more of the full depth of the flow passages 32, 34 in the area where the flow diverters 40, 42 are located. The height of the flow diverters 40, 42 can vary depending on operating conditions and the desired exit velocity profile.

As described above, the flow diverters 40, 42 are shaped or profiled so that the polymeric material flow has a velocity profile that is generally constant across the lateral length of the die 26 as it enters the die 26 at the flow outlet end 18 of the flow channel 14. In accordance with the principles of the present invention, and as shown in FIGS. 1-4, the flow diverters 40, 42 are removably secured within the flow channel 14 of the extruder head 12 such that the flow diverters 40, 42 can be easily removed and reshaped or reprofiled as may be necessary to achieve the desired velocity profile of the polymeric material flow at the flow outlet end 18 of the flow channel 14.

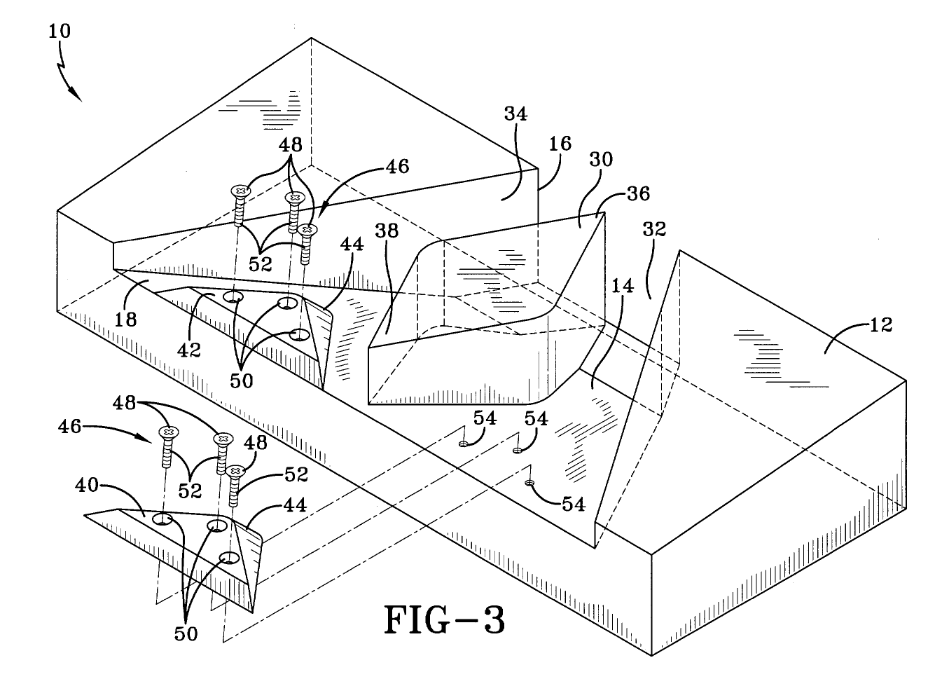

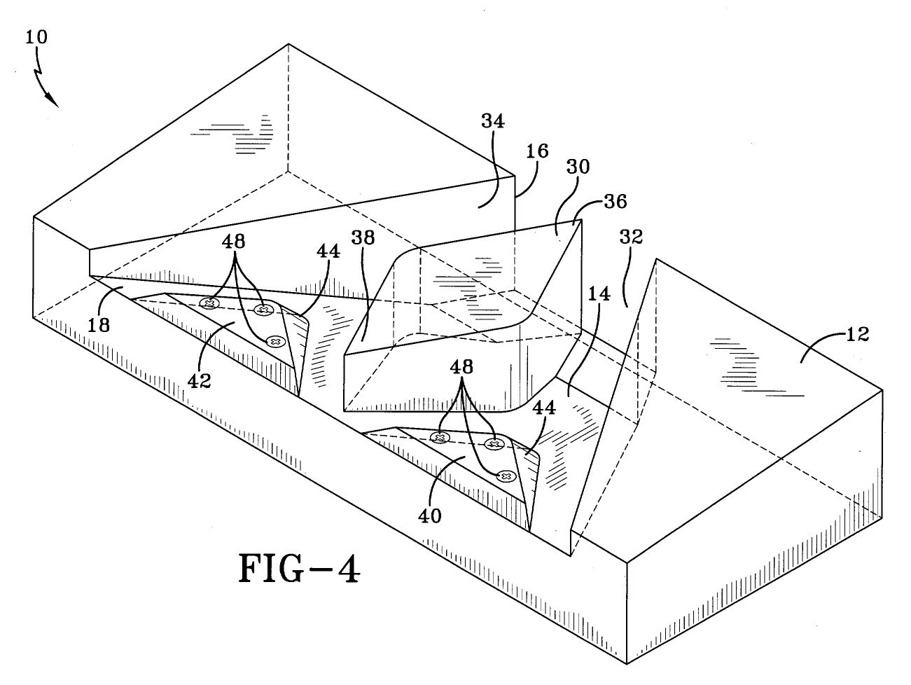

In one embodiment, as shown in FIGS. 1-4, fastening mechanisms 46, such as threaded fasteners 48, are provided which extend through bores 50 (FIG. 3) formed through the flow diverters 40, 42. The threaded ends 52 (FIG. 3) of the fasteners 48 engage threaded bores 54 (FIG. 3) formed in the extruder head 12 such that the flow diverters 40, 42 are held securely in place within the flow channel 14 as shown in FIG. 4, and can be easily removed, as may be necessary, simply by removing the fasteners 48 as shown in FIG. 3. In this way, each flow diverter 40, 42, which may weigh about 10 pounds, can be unbolted from the extruder head 12 and transported to any location for adjustment in its shape or profile by machining or by manual grinding so that the desired velocity profile at the flow outlet end 18 of the flow channel 14 is achieved. This capability to remove and transport the flow diverters 40, 42 for adjustment greatly simplifies the prior adjustment process which required the massive one-piece extruder head, which may weigh about 1,000 pounds or more, to be removed and transported for machining or manual grinding. By removably securing the flow diverters 40, 42 within the flow channel 14 of the extruder head 12, considerable time and expense is saved for adjusting the flow properties of the flow channel 14 since now only the flow diverters 40, 42 need be removed and transported for adjustment.

While fasteners 48 are shown for removably securing the flow diverters 40, 42 within the flow channel 14 of the extruder head 12, it is contemplated that other mechanical fastening systems are possible as well which will serve to securely connect the flow diverters 40, 42 to the extruder head 12, yet allow the flow diverters 40, 42 to be easily removed as may be necessary for adjustment. The present invention contemplates any fastening mechanism which will provide this desired function as will be appreciated by those of ordinary skill in the art. To this end, it is contemplated that the fastening mechanisms may comprise separate components, such as bolts, screws, or any other releasably securable fastening devices, which provide the desired fastening function. Alternatively, it is contemplated that the fastening mechanisms may be integrally formed on the flow diverters 40, 42, the extruder head 12, or both, such that the integral fastening mechanisms releasably secure the flow diverters 40, 42 within the flow channel 14 of the extruder head 12 in a secure but easily removable fashion.

While not shown, it will be readily appreciated that the flow diverters 40, 42 are adapted to be similarly removably connected to a removable flow channel (not shown) when such a component is used in combination with the extruder head 12. In this embodiment, the removable flow channel (not shown) includes threaded bores (not shown) for receiving the threaded ends 52 (FIG. 3) of the fasteners 48 to removably secure the flow diverters 40, 42 to the removable flow channel (not shown).

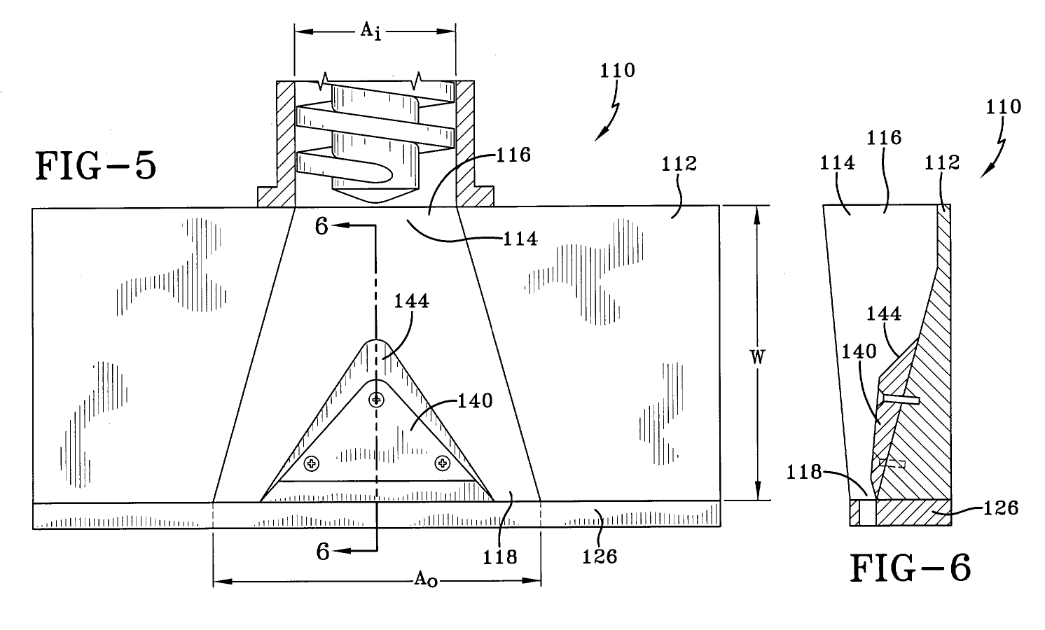

Referring now to FIGS. 5-8, an extrusion system 110 is shown in accordance with another embodiment of the present invention having a single cavity extruder head 112, where like numerals represent like parts to the extrusion system 10 of FIGS. 1-4. In this embodiment, the single cavity extruder head 112 has a flow channel 114 machined therein for conveying polymeric material through the extruder head 112 between a flow inlet end 116 and a flow outlet end 118 of the flow channel 114.

As shown in FIG. 6, at least one or both of the surfaces of the flow channel 114 tapers inwardly from the flow inlet end 116 to the flow outlet end 118 of the flow channel 114 so as to flatten the cross-sectional area as the polymeric material flow approaches the flow outlet end 118 of the flow channel 114 and prior to entering into the extruder profile forming die 126.

In this embodiment, a single flow diverter 140 is removably secured within the flow channel 114 proximate the flow outlet end 118 of the flow channel 114. The flow diverter 140 is generally triangular in shape and includes a leading apex 144 directed toward the flow inlet end 116 of the flow channel 114. Similar to the flow diverters 40, 42 of the dual cavity extruder head 12, the flow diverter 140 is shaped or profiled so that the polymeric material flow has a velocity profile that is generally constant or as desired across the lateral length of the die 126 as it enters the die 126 at the flow outlet end 118 of the flow channel 114.

In accordance with the principles of the present invention, the flow diverter 140 is removably secured within the flow channel 114 of the extruder head 112 so that the flow diverter 140 can be easily removed and reshaped or reprofiled as necessary to achieve the desired velocity profile of the polymeric material flow at the flow outlet end 118 of the flow channel 114.

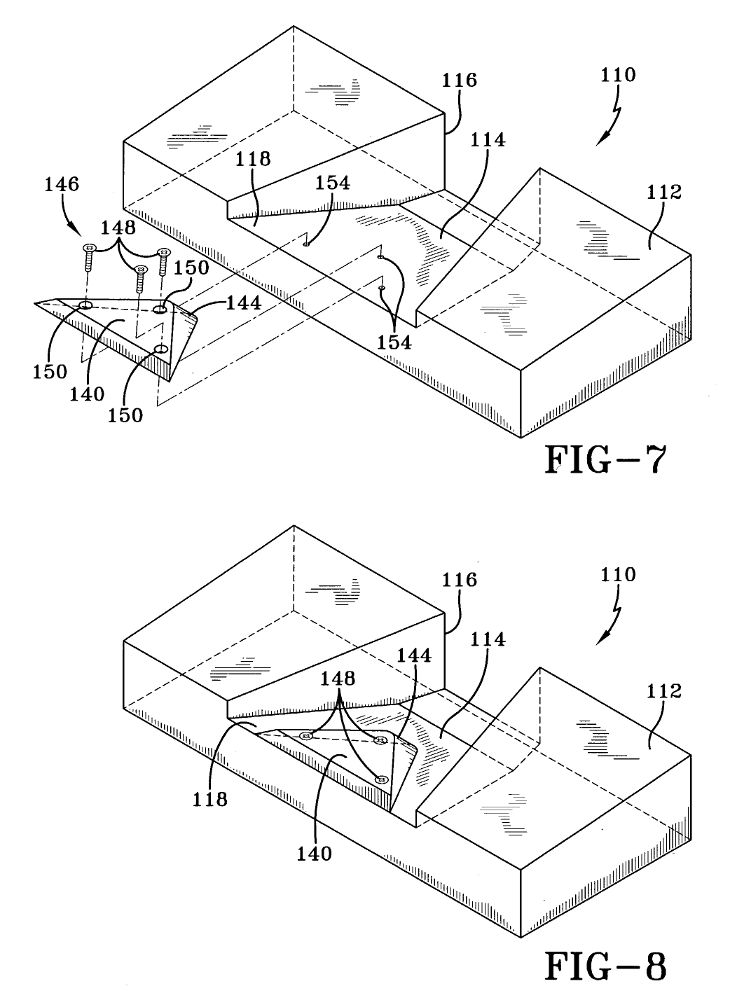

As with the dual cavity extruder head 12 of FIGS. 1-4, the single cavity extruder head 112 includes fastening mechanisms 146 (FIG. 7), such as threaded fasteners 148 (FIG. 7), which extend through bores 150 (FIG. 7) formed through the flow diverter 140 and engage with threaded bores 154 (FIG. 7) formed in the extruder head 112. In this way, the flow diverter 140 is held securely in place within the flow channel 114 as shown in FIG. 8, and can be easily removed as may be necessary for adjustment simply by removing the fasteners 148 as shown in FIG. 7. Of course, alternative fastening mechanisms, such as those described in detail above, which function to releasably secure the flow diverter 140 to the extruder head 112 are contemplated as well.

While not shown, it will be readily appreciated that the flow diverter 140 is adapted to be similarly removably connected to a removable flow channel (not shown) when such a component is used in combination with the extruder head 112.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicants' general inventive concept.

Having described the invention, what is claimed is:

1. An extruder head for use in forming at least one strip of polymeric material, comprising:
an extruder head;
a flow channel associated with the extruder head and having a flow inlet end and a flow outlet end; and
a flow diverter removably secured within the flow channel of the extruder head.

2. The extruder head of claim 1 further comprising a fastening mechanism operable to removably secure the flow diverter within the flow channel of the extruder head.

3. The extruder head of claim 2 wherein the fastening mechanism comprises at least one fastener removably securing the flow diverter within the flow channel of the extruder head.

4. The extruder head of claim 1 further comprising a flow dam positioned within the flow channel proximate the inlet end and separating the flow channel into a first flow passage and a second flow passage.

5. The extruder head of claim 4 further comprising a pair of flow diverters removably secured within the flow channel of the extruder head, each of the pair of flow diverters being located in one of the first and second flow passages.

6. The extruder head of claim 5 further comprising a plurality of fastening mechanisms operable to removably secure the pair of flow diverters within the flow channel of the extruder head.

7. The extruder head of claim 6 wherein each fastening mechanism comprises at least one fastener removably securing one of the flow diverters within the flow channel of the extruder head.

8. The extruder head of claim 1 further comprising a profile forming die connected to the extruder head proximate the flow outlet end of the flow channel.

9. An extruder head for use in forming at least one strip of polymeric material, comprising:
an extruder head;
a flow channel associated with the extruder head and having a flow inlet end and a flow outlet end;
a flow diverter positioned within the flow channel and having at least one bore extending therethrough; and
at least one fastener extending through the bore of the flow diverter and removably securing the flow diverter within the flow channel of the extruder head.

10. The extruder head of claim 9 further comprising a flow dam positioned within the flow channel proximate the inlet end and separating the flow channel into a first flow passage and a second flow passage.

11. The extruder head of claim 10 further comprising a pair of flow diverters removably secured within the flow channel of the extruder head, each of the pair of flow diverters being located in one of the first and second flow passages and having at least one bore extending therethrough.

12. The extruder head of claim 11 further comprising at least one fastener extending through the bore of each flow diverter and removably securing the flow diverters within the flow channel of the extruder head.

13. The extruder head of claim 9 further comprising a profile forming die connected to the extruder head proximate the flow outlet end of the flow channel.

14. A method of making an extruder head for use in forming at least one strip of polymeric material, comprising:
associating a flow channel with the extruder head, the flow channel having a flow inlet end and a flow outlet end; and
removably securing a flow diverter within the flow channel of the extruder head.

15. The method of claim 14, wherein the securing step comprises:
using a fastening mechanism to removably secure the flow diverter within the flow channel of the extruder head.

16. The method of claim 15, wherein the fastening mechanism comprises at least one fastener.

17. The method of claim 14, wherein the securing step comprises:
forming at least one bore through the flow diverter; and
extending a fastening mechanism through the bore of the flow diverter to removably secure the flow diverter within the flow channel of the extruder head.

18. The method of claim 17, wherein the fastening mechanism comprises at least one fastener.

19. The method of claim 14, further comprising;
connecting a profile forming die to the extruder head proximate the flow outlet end of the flow channel.
